(19) United States
(12) Patent Application Publication
(10) Pub. No.: US 2009/0211080 A1
(43) Pub. Date: Aug. 27, 2009

(54) METHOD AND APPARATUS FOR SHIMMING A MAGNET

(76) Inventors: Richard Ian Gowland, Oxon (GB); Matthew John Longfield, Oxon (GB)

Correspondence Address: SCHIFF HARDIN, LLP;PATENT DEPARTMENT, 6600 SEARS TOWER, CHICAGO, IL, 60606-6473, US

(21) Appl. No.: 12/372,959

(22) Filed: Feb. 18, 2009

(30) Foreign Application Priority Data
Feb. 25, 2008 (GB) 0803358.1
Jul. 17, 2008 (GB) 0813085.8

(51) Int. Cl. H01F 7/06

(52) U.S. Cl. 29/602.1

(57) ABSTRACT

In a method of producing a shim, for each of several layers, a first layer of powdered magnetic material is deposited, and selectively bonding together in regions of the layer where presence of the magnetic material is required. Unbonded powdered magnetic material is removed from the layer, to leave gaps. A powdered magnetically inert material is deposited into the gaps and bonded together in regions of the layer where presence of the magnetic material is not required.

### BACKGROUND OF THE INVENTION

1. Field of the Invention

The present invention relates to methods and apparatus for shimming a magnetic field, that is, to influence a generated magnetic field in order to bring the magnetic field distribution closer to a desired magnetic field distribution. In particular, though not exclusively, the present invention relates to such shimming of magnets for producing a base magnetic field for MRI imaging systems.

2. Description of the Prior Art

In order to create a good quality MRI image, the basic magnetic field of the system must have a low amount of variability. Many factors can affect the magnetic field. These include: dimensional variability in the magnet, iron girders and reinforcement in the structure of the building the magnet is in. Due to the second item, it is necessary to be able to alter the field of the magnet on site in order to bring it to the required homogeneity for imaging.

Current shimming methods take several iterations that require the magnet to be ramped to field and then ramped down again costing time and money. In each iteration, the field inhomogeneities are measured, and a compensating distribution of magnetic material, typically iron or steel shim plates, is calculated. The calculated distribution of shim plates is placed in position, and a next iteration is started. This is repeated until a satisfactory field is achieved. The shim plates that are used are counted by hand and mistakes often occur. The current methods are low resolution and the results of placing the shim plates often do not match the theoretical prediction.

Current solutions use an analysis tool to determine where iron shim plates should be placed in order to get a more homogenous resultant field. Most existing solutions use large numbers of shims made from thin iron sheet which are placed in pockets within a tray. The analysis tool for current solutions is restricted to using these pockets and determining the amount of iron required in each. This is an approximate solution and often requires multiple attempts before a working solution is found.

The current solution to alter field of an MRI system is to place pre-shaped iron pieces in set locations around the bore of the magnet. The quantity of iron required at each location is defined using specialist software. Due to the fixed sizes and positions available for the shim iron, the match is by nature inexact and may require more iron than the ‘optimal’ solution and take several iterations to get the best possible homogeneity. In addition, the iron is susceptible to inductive heating which can cause the properties of the shim plates to change.

The present invention provides methods and apparatus for the production of magnetic shims from 3-dimensional data. There are many known methods of creating physical objects from 3-dimensional computer data. For example, Stereo laser sintering (where plastic powder is fused using a laser), and the “z-corp.” system (where powder is bonded using glue sprayed on by printer heads). The aforementioned methods are single material processes. Multi-material processes are known, and include extrusion based systems and multi-head printer head based systems.

Korean Application KR 20010094182 discloses a method for manufacturing a rapid prototype using powdered magnetic material. Korean Application KR 20060022243 discloses a thermoplastic powder material system for appearance models generated from 3D printing systems. United States Patent Application Publication No. 2006/014146 discloses a three-dimensional printer of the type suitable for use in implementing the present invention.

### SUMMARY OF THE INVENTION

An object of the present invention is to provide at least one of the following advantages over known arrangements for shimming a magnet:

a magnet may be shimmed in one iteration;

shim counting mistakes are avoided;

the overall homogeneity of the magnetic field is improved because of improved shim resolution.

The above object is achieved in accordance with the present invention in a method and an apparatus for producing a shim wherein, for each of several layers, a first layer of powdered magnetic material is deposited and selectively bonded together in regions of the layer where the presence of the magnetic material is required, and wherein unbonded powdered magnetic material is removed from the layer, thereby leaving gaps. A powdered magnetically inert material is deposited into the gaps and bonded together in regions of the layer where the presence of the magnetic material is not required.

### DESCRIPTION OF THE DRAWINGS

FIG. 1 shows apparatus of an embodiment of the present invention, after laying down a layer of powdered magnetic material.

FIGS. 1A and 1B show example bonding means in operation.

FIG. 2 shows an electromagnet passing over the layer of powdered magnetic material, picking up any unbonded material.

FIG. 3 shows a layer of powdered magnetically inert material being laid down.

FIG. 4 shows a next layer of powdered magnetic material being laid down.

FIG. 5 shows apparatus of another embodiment of the present invention, after laying down a layer of magnetically inert powder.

FIG. 6 shows a gas nozzle passing over the layer of magnetically inert powder, displacing any unbonded material.

FIG. 7 shows a layer of powdered magnetic material being laid down.

FIG. 8 shows a next layer of powdered magnetically inert material being laid down.

FIG. 9 shows a low resolution arrangement of shims according to the prior art.

FIG. 10 shows a high-resolution shim arrangement according to a certain embodiment of the present invention.

FIG. 11 shows a stage in the manufacturing of a shim according to an embodiment of the invention.

### DESCRIPTION OF THE PREFERRED EMBODIMENTS

The present invention provides methods and apparatus for the production of magnetic shims from 3-dimensional data. The present invention provides an apparatus for producing a custom shim comprising powdered magnetic material and a powdered magnetically inert material; and a corresponding method for producing such a shim. The present invention may be used on site to manufacture required shims directly from the calculated requirements. This means that magnetic field inhomogeneities caused by the environment at the site may be taken into account, and that a customized shim, producing optimized overall magnetic field distribution may be produced on site.

The present invention provides shims which are not restricted in the shape of the magnetic material that can be used, allowing any preferred shape to the shim material. However, when the present invention is applied to existing magnet designs, it is likely that the shims will be designed to fit within the exiting shim trays. The present invention should give a more accurate solution, with less magnetic material and, potentially, require fewer iterations (or even eliminate iterations altogether) before satisfactory homogeneity is achieved. It would also reduce the eddy currents induced as the magnetic material is present in the form of particles, each typically surrounded by a bonding agent. Cooling channels may be built into the shim to allow the shim to vent excess heat. The solution of the present invention also has the benefit of being able to be applied to all systems regardless of existing shim tray design, as the shape of the shim is defined as it is made.

Having analyzed the installation site, shimming software produces a 3D model of the required iron shim. This model is divided into layers which are then used to drive the apparatus of the present invention, and to create corresponding layers of the shim.

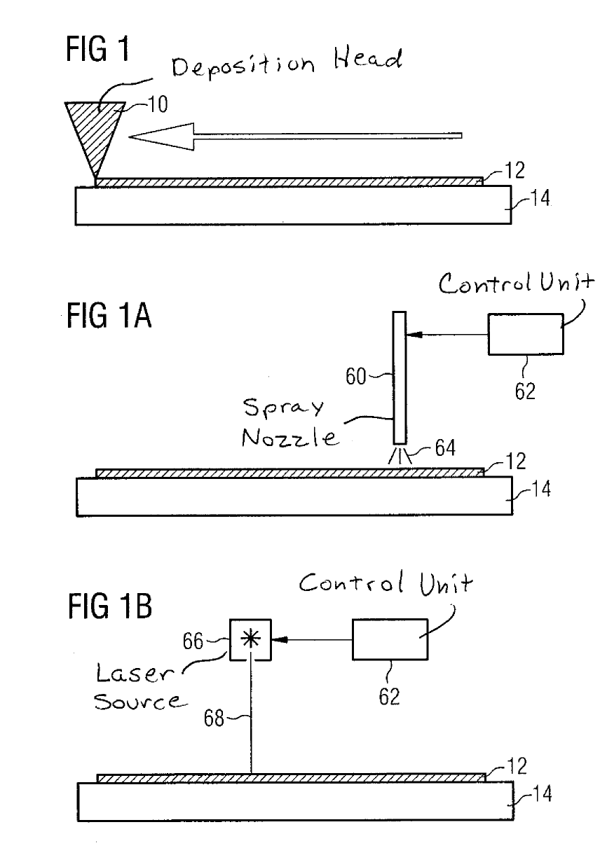

FIG. 1 schematically illustrates a step in a process of manufacturing a shim, according to the present invention. In FIG. 1, a first layer of the model is being realized, as a first layer of the shim. A material deposition head 10 of the manufacturing apparatus lays down a layer 12 of powdered magnetic material on to a bed 14 of the apparatus.

A bonding agent such as an adhesive is then selectively applied to the powdered magnetic material, for example by spraying from above. Alternatively, local heating (for example, by means of a laser or hot air) may be applied to thermally activated bonding agent, such as a powdered thermoplastic, which would be laid down before, with, or after, the powdered magnetic material. This step would bond only the powdered magnetic material in regions of the layer in which magnetic material is required by the model in the finished shim.

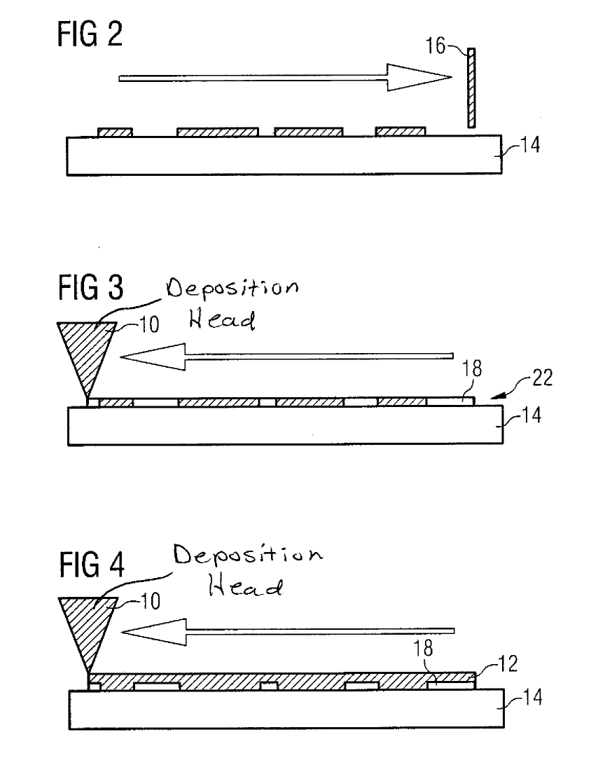

Unbonded magnetic material is then removed from the layer, for example by passing a weak electromagnet 16 over the layer of powdered magnetic material picking up any unbonded material (see FIG. 2). In alternative arrangements, a current of gas may be blown onto the layer 12 to displace the unbonded magnetic material. Alternatively, the structure may be briefly inverted such that unbonded magnetic material is displaced by gravity.

A layer of powdered magnetically inert material 18 is then laid down (see FIG. 3) by a material deposition head 20, which may be a different material deposition head from that 10 which laid down the powdered magnetic material in FIG. 1. The material deposition head 20 also removes any magnetically inert material above the height of one layer. This leaves a layer 22 of alternating regions of bonded powdered magnetic material 12 and powdered magnetically inert material 18. The magnetically inert material is then be bonded by any suitable method, for example the methods discussed with reference to the bonding of the powdered magnetic material.

The bed 14 then lowers, or the heads 10, 20 rise, or a combination of both, by the thickness of one layer and a next layer of powdered magnetic material 12 is laid down (see FIG. 4). Bonding and excess removal would follow, as discussed with reference to FIG. 2.

It may be that the required pattern of bonded powdered magnetic material consists of a complete covering of powdered magnetic material. In such a case, it is not necessary to perform the steps of FIG. 3, the deposition, leveling and bonding of a magnetically inert layer 18. Similarly, if a whole layer of magnetically inert material 18 is to be deposited, the steps of deposition, binding and excess removal of powdered magnetic material may be omitted for that layer.

These steps repeat until the shim is complete. To create cooling channels, corresponding areas of magnetically inert material 18 may be left unbonded in certain layers. This unbonded material would then be removed by agitating the completed part. It is also possible to include additional features such as pipe work, wire harnesses, sensors, fasteners and active shim coils by placing them into the shim during the build, most suitably within areas of magnetically inert material 18.

If the shims need replacing then the old shims could be recycled by grinding them into powder and separating the magnetic material from the magnetically inert material using magnets.

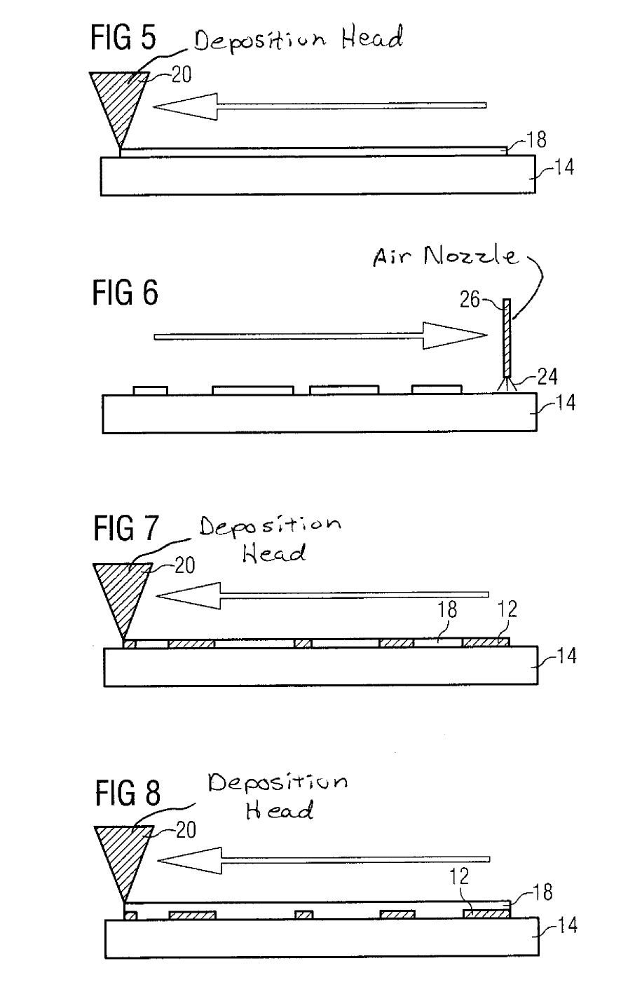

In an alternative embodiment, the order of application of the magnetic material 12 and the magnetically inert material 18 is reversed, as will now be discussed with reference to FIGS. 5-8.

In such embodiments, for each layer of the model, a material deposition head 20 of the apparatus lays down a layer of magnetically inert powder 18 on to a bed 14 of the apparatus. A bonding agent such as an adhesive is then selectively applied to the magnetically inert powder, for example by spraying from above. Alternatively, local heating (for example, by means of a laser or hot air) may be applied to thermally activated bonding agent, such as a powdered thermoplastic, which would be laid down before, with, or after, the magnetically inert powder. In another alternative, the magnetically inert layer consists of a thermoplastic material, which is selectively fused together by local heating. This step would bond only the magnetically inert power in regions of the layer in which magnetic material is not required by the model in the finished shim.

FIG. 1A illustrates an example bonding means for selectively bonding layer 12 of magnetic material. In the example, a spray nozzle 60, for example, a dispenser similar to the print head of an ink jet printer, is moved across the surface of the deposited magnetic material, and is controlled by a control unit 62 to deposit an adhesive 64 only in areas in which the magnetic material 12 is required to remain. The spray nozzle may have one or more controlled outlets, and may scan back and forth in a raster motion. Alternatively, the spray nozzle may have a row of controlled outlets, and move once across the surface of the layer, selectively spraying the whole surface at once. In an extreme embodiment, an array of outlets equal in size to the surface of the layer may selectively spray the whole surface in a single step, resulting in very fast operation. The control unit 62 may be responsible both for the motion of the nozzle 60, and operation of its outlet(s). In alternative embodiments, either the nozzle may move, or the bed 14, or a combination of both—for example, the bed may be arranged to move in a direction in the plane of FIG. 1, while the nozzle may be controlled to move perpendicular to that direction.

In a similar embodiment, a nozzle may be arranged to direct hot air onto the layer of magnetic material, which has been provided with a bonding agent, such as a powdered thermoplastic, mixed into the magnetic material. The alternative arrangements of outlets and arrangements providing relative motion between the nozzle and the bed described in the preceding paragraph may also be applied to such embodiments.

FIG. 1B illustrates another example bonding means for selectively bonding layer 12 of magnetic material. In the example, a laser source 66, is moved across the surface of the deposited magnetic material 12, and is controlled by a control unit 62 to activate the laser beam 68 only in areas in which the magnetic material 12 is required to remain. The magnetic material should include a thermally activated bonding agent, such as a powdered thermoplastic, mixed with magnetic material. The laser 66 may remain in position while the bed 14 scans back and forth in a raster motion; or the bed 14 may remain in position while the laser beam 68 scans back and forth in a raster motion. A controlled mirror may be provided to the cause the laser beam 68 to scan back and forth in a raster motion. The control unit 62 may be responsible both for the motion of the laser beam 68, and its selective operation. In alternative embodiments, either the laser beam 68 may move, or the bed 14, or a combination of both—for example, the bed may be arranged to move in a direction in the plane of FIG. 1, while the laser beam 68 may be controlled, typically by a controlled mirror, to move perpendicular to that direction.

Any unbonded magnetically inert material is then displaced from the structure, for example by passing a current of gas 24, such as blown air, over the structure from a nozzle 26 (see FIG. 6). Alternatively, the structure may be briefly inverted, with unbonded magnetically inert material then being displaced by gravity.

A layer of powdered magnetic material 12 is then laid down (see FIG. 7) by a material deposition head 10, which may be a different material deposition head from that 20 which laid down the magnetically inert powder 18 in FIG. 5. The material deposition head also removes any magnetic material above the height of one layer. This leaves a layer of alternating regions of magnetic 12 and magnetically inert 18 materials. The magnetic material is then bonded by any suitable method, for example the methods discussed with reference to the bonding of the magnetically inert powder.

The bed then lowers, or the deposition heads 10, 20 rise, or a combination of both, by the thickness of one layer and the next layer of magnetically inert powder is laid down (see FIG. 8). Bonding and excess removal would follow, in the manner discussed in relation to FIG. 6.

It may be that the required pattern of bonded powdered magnetic material 12 is a complete covering. In such a case, it is not necessary to perform the steps of the deposition, leveling and bonding of a magnetically inert layer 18. Similarly, if a whole layer of magnetically inert material 18 is to be deposited, the steps of deposition, excess removal and binding of powdered magnetic material 12 may be omitted for that layer.

These steps repeat until the shim is complete. To create cooling channels, corresponding areas of magnetic material would be left unbonded in certain layers. This material may then be removed by agitating the completed part. It would also be possible to include additional features such as pipe work, wire harnesses, sensors, fasteners and active shim coils by placing them into the shim during the build, most suitably within areas of magnetically inert material. If the shims need replacing then the old shims could be recycled by grinding them into powder and separating the magnetic material from the magnetically inert material using magnets.

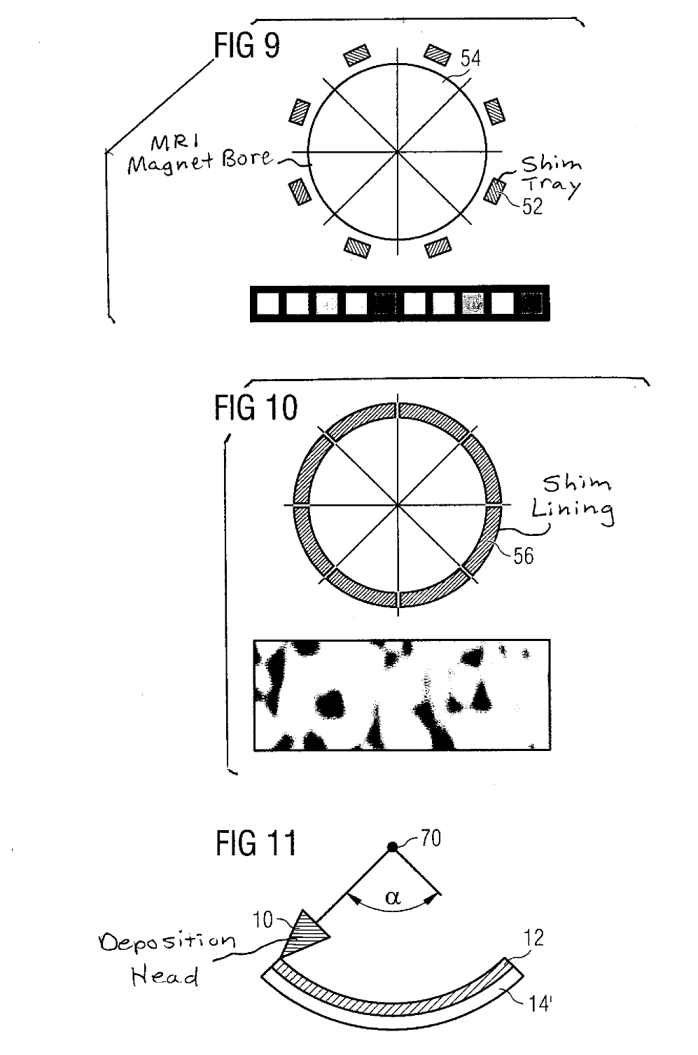

FIG. 9 illustrates a low resolution arrangement of shims according to the prior art. As discussed above, sheets of iron or steel are placed in pockets in shim trays 52, arranged around the bore 54 of the magnet. The upper part of FIG. 9 schematically illustrates a radial cross-section through a shim arrangement of a cylindrical magnet, according to the prior art. The shim trays 52 are schematically represented as shaded rectangles placed about the axis, at intervals around the bore of the magnet. The lower part of FIG. 9 schematically illustrates the relative density of shim material around the circumference of the circle illustrated, beginning and ending at the “12 o'clock” position, over an axial slice of a certain length. The relative darkness of the grey squares illustrated represents the relative density of magnetic shim material at the corresponding radial position. The black framing represents positions at which shims are not present.

FIG. 10 represents a high-resolution shim arrangement according to a certain embodiment of the present invention. As mentioned above, the present invention may provide planar shims for placement within conventional shim trays as represented in FIG. 9. FIG. 10 however represents a more advanced arrangement, in which the method and apparatus of the present invention is used to produce curved shims, which are assembled together to produce a complete shim lining 56 within the bore of the cylindrical magnet represented in the figure. The shim lining is represented as the thick, shaded, circle 56 within the upper part of FIG. 10. As shown, it is substantially continuous around the illustrated slice. The gaps shown may accommodate mechanical mounting for the shim pieces, and may provide mechanical expansion gaps to accommodate thermal expansion of the shims. The lower part of FIG. 10 schematically illustrates the relative density of shim material around the circumference of the circle illustrated, beginning and ending at the “12 o'clock” position, over an axial slice of a certain length. The relative darkness of grey represents the relative density of magnetic shim material at the corresponding radial and axial position. As shown, the shim is substantially continuous both axially and around the bore of the magnet. As shown, the present invention provides shims which can vary in magnetic material density with relatively fine resolution, both circumferentially and axially, and substantially continuously within the bore of the magnet. The present invention accordingly provides methods and apparatus for producing magnetic shims with improved resolution in both radial and circumferential dimensions.

FIG. 11 schematically represents a stage in the manufacture of curved shims 56 such as shown in FIG. 11, at a stage corresponding to that of FIG. 1. A layer of magnetic material 12 has been laid onto a curved bed 14′ by a material deposition head 10. The axis of curvature of the bed is represented at 70, and the material deposition head 10 is arranged to rotate about the axis 70 through an angular extent □, rather than to translate across the surface of the bed 14, as was the case with the embodiment of FIG. 1. The various methods and apparatus described with respect to the embodiments of FIGS. 1-8 may be simply adapted to such embodiments, each time by replacing translation across the surface of the bed 14 with rotation about the axis 70 by angular extent □.

As will be clear to those skilled in the art, embodiments in which shims of the present invention are placed within a shim tray of the prior art may be represented by a varying density of magnetic shim material, similar to that shown in the lower part of FIG. 10, within pockets as shown in the lower part of FIG. 9.

The invention is a method and apparatus for producing shims to create a homogeneous magnetic field within magnets, and is considered suitable for improving the homogeneity of the magnetic field in the main field magnet of an MRI system. The apparatus and method of the present invention enables the construction of a three-dimensional shim from layers which are each made up of areas of magnetic material and/or areas of a magnetically inert material. These areas are defined by a model produced by shimming software. The advantages of this approach are that it reduces the discretisation required, reduces the parts required on site, potentially reduces the time required to shim the magnet and reduces and dissipates the heat generated by inductive heating.

In example embodiments, the powdered magnetic material may be selected from the list: iron; mild steel; non-austenitic grades of stainless steel; and the powdered magnetically inert material may be selected from the list: ceramics, sand, and plastics. Of course, other materials may be used as required, or according to other properties required of the completed shim. While the present description refers to the magnetic and magnetically inert materials as being powdered, such definition should be understood to include any material in the form of fine particles, such as a granular material, or powders as such. The particles should preferably have dimensions smaller than the resolution of the pattern to be formed in the powdered materials. Typically, the ‘powdered’ materials should have a particle size at least one, and preferably at least two, order(s) of magnitude lower than the smallest feature which will be formed by selective bonding in the manufacture of the shim.

Although modifications and changes may be suggested by those skilled in the art, it is the intention of the inventors to embody within the patent warranted hereon all changes and modifications as reasonably and properly come within the scope of their contribution to the art.

We claim as our invention:

1. A method of producing a shim for altering a magnetic field, comprising the steps of:
measuring a magnetic flux density of an initial magnetic field over a defined region;
calculating a three-dimensional distribution of a magnetic material which, when positioned at a predetermined position, would alter the magnetic flux distribution of the initial magnetic field to more closely correspond to a desired magnetic flux distribution; and
manufacturing a shim containing the calculated distribution of the magnetic material by:
(a) dividing the calculated three-dimensional distribution into layers;
(b) for a first layer, depositing a first layer of powdered magnetic material on to a bed;
(c) selectively bonding together powdered magnetic material of the layer in regions of the layer where presence of the magnetic material is required in the calculated three-dimensional distribution;
(d) removing unbonded powdered magnetic material from the layer, to leave only bonded magnetic material in the corresponding regions; and gaps in other regions of the layer;
(e) depositing a powdered magnetically inert material into the gaps in the layer;
(f) bonding together powdered magnetically inert material of the layer in regions of the layer where presence of the magnetic material is not required in the calculated three-dimensional distribution;
(g) applying a further layer of powdered magnetic material over the previous layer; and
(h) repeating steps (g) and (c)-(f) to build up successive layers of bonded powdered magnetic material and bonded powdered magnetically inert material until the resultant structure corresponds to the calculated three-dimensional distribution of magnetic material.

2. A method according to claim 1 comprising, in step (f), leaving selected areas of the powdered magnetically inert material unbonded, and subsequently removing said selected areas from the structure to create channels through the shim.

3. A method according to claim 1 comprising, in steps (b) and (g), depositing the powdered magnetic material by a deposition head, and also using said deposition head to spread the powdered magnetic material to a constant thickness.

4. A method according to claim 1 comprising, in step (e), depositing the powdered magnetically inert material by a deposition head, and also using said deposition head to spread the powdered magnetically inert material to a constant thickness within the gaps, and to remove powdered magnetically inert material from upper surfaces of the bonded powdered magnetic material.

5. A method according to claim 1 comprising placing additional features into the shim prior to the bonding step.

6. A method according to claim 5 comprising selecting the additional feature from the group consisting of pipe work, wire harnesses, sensors, fasteners and active shim coils.

7. A method according to claim 1 comprising implementing step (d) by passing an electromagnet over the layer of powdered magnetic material, to pick up any unbonded powdered magnetic material.

8. A method according to claim 1 comprising, in at least one of the bonding steps (c) and (f), performing the bonding by applying bonding agent to the powder by spraying from above.

9. A method according to claim 1 comprising, in at least one of the bonding steps (c) and (f), performing the bonding by locally heating a layer of thermally activated bonding agent laid down before, or with, the powder.

10. A method for shimming a magnet, comprising the steps of:
measuring a magnetic flux density of an initial magnetic field over a defined region;
calculating a three-dimensional distribution of a magnetic material which, when positioned at a predetermined position, would alter the magnetic flux distribution of the initial magnetic field to more closely correspond to a desired magnetic flux distribution;
manufacturing a shim containing the calculated distribution of the magnetic material by:
(a) dividing the calculated three-dimensional distribution into layers;
(b) for a first layer, depositing a first layer of powdered magnetic material on to a bed;
(c) selectively bonding together powdered magnetic material of the layer in regions of the layer where presence of the magnetic material is required in the calculated three-dimensional distribution;
(d) removing unbonded powdered magnetic material from the layer, to leave only bonded magnetic material in the corresponding regions; and gaps in other regions of the layer;
(e) depositing a powdered magnetically inert material into the gaps in the layer;
(f) bonding together powdered magnetically inert material of the layer in regions of the layer where presence of the magnetic material is not required in the calculated three-dimensional distribution;
(g) applying a further layer of powdered magnetic material over the previous layer;
(h) repeating steps (g) and (c)-(f) to build up successive layers of bonded powdered magnetic material and bonded powdered magnetically inert material until the resultant structure corresponds to the calculated three-dimensional distribution of magnetic material; and
positioning the manufactured shim in the predetermined position.

11. An apparatus for producing a three-dimensional shim, comprising;
a bed;
a deposition head arranged for movement parallel to an upper surface of the bed, positioned a variable distance above the bed, thereby to deposit respective layers of magnetic, or respectively magnetically inert, powder of constant thickness on the bed;
a bonding that selectively bonds regions of applied powder by applying a bonding agent applied to a powder layer;
a control unit configured to control the bonding to selectively bond regions of powder according to a calculated three-dimensional distribution of magnetic material; and
a displacement unit that displaces unbonded regions of applied powder.

12. An apparatus according to claim 11 wherein the bed is planar and the deposition head moves by translation in a direction parallel to the bed.

13. An apparatus according to claim 12 wherein the bed is curved and the deposition head moves by rotation about the axis of curvature of the bed.

14. A method of producing a shim for altering a magnetic field, comprising the steps of:
measuring a magnetic flux density of an initial magnetic field over a defined region;
calculating a three-dimensional distribution of a magnetic material which, when positioned at a predetermined position, would alter the magnetic flux distribution of the initial magnetic field to more closely correspond to a desired magnetic flux distribution; and
manufacturing a shim containing the calculated distribution of the magnetic material by:
(a) dividing the calculated three-dimensional distribution into layers;
(b) for a first layer, depositing a first layer of powdered magnetically inert material on to a bed;
(c) selectively bonding together powdered magnetically inert material of the layer in regions of the layer where presence of the magnetic material is not required in the calculated three-dimensional distribution;
(d) removing unbonded powdered magnetically inert material from the layer, to leave only bonded magnetically inert material in the corresponding regions; and gaps in other regions of the layer;
(e) depositing a powdered magnetic material into the gaps in the layer;
(f) bonding together powdered magnetic material of the layer in regions of the layer where presence of the magnetic material is required in the calculated three-dimensional distribution;
(g) applying a further layer of powdered magnetically inert material over the previous layer; and
(h) repeating steps (g) and (c)-(f) to build up successive layers of bonded powdered magnetic material and bonded powdered magnetically inert material until the resultant structure corresponds to the calculated three-dimensional distribution of magnetic material.

15. A method according to claim 14 comprising, in step (f), leaving selected areas of the powdered magnetic material unbonded, and subsequently removing said selected areas from the structure to create channels through the shim.

16. A method according to claim 14 comprising, in steps (b) and (g), depositing the powdered magnetically inert material by a deposition head, and also using said deposition head to spread the powdered magnetic material to a constant thickness.

17. A method according to claim 1 comprising, in step (e), depositing the powdered magnetic material by a deposition head, and also using said deposition head to spread the powdered magnetic material to a constant thickness within the gaps, and to remove powdered magnetic material from upper surfaces of the bonded powdered magnetically inert material.

18. A method according to claim 14 comprising placing additional features into the shim prior to the bonding step.

19. A method according to claim 18 comprising selecting the additional feature from the group consisting of pipe work, wire harnesses, sensors, fasteners and active shim coils.

20. A method as claimed in claim 14 comprising implementing step (d) by passing a flow of gas over the layer of powdered magnetically inert material to displace any unbonded powdered magnetic material.

21. A method as claimed in claim 14 comprising implementing step (d) by inverting said structure to displace any unbonded powdered magnetic material by gravity.

22. A method according to claim 14 comprising, in at least one of the bonding steps (c) and (f), performing the bonding by applying bonding agent to the powder by spraying from above.

23. A method according to claim 14 comprising, in at least one of the bonding steps (c) and (f), performing the bonding by locally heating a layer of thermally activated bonding agent laid down before, or with, the powder.

24. A method for shimming a magnet, comprising the steps of:
measuring a magnetic flux density of an initial magnetic field over a defined region;
calculating a three-dimensional distribution of a magnetic material which, when positioned at a predetermined position, would alter the magnetic flux distribution of the initial magnetic field to more closely correspond to a desired magnetic flux distribution;
manufacturing a shim containing the calculated distribution of the magnetic material by:
(a) dividing the calculated three-dimensional distribution into layers;
(b) for a first layer, depositing a first layer of powdered magnetically inert material on to a bed;
(c) selectively bonding together powdered magnetically inert material of the layer in regions of the layer where presence of the magnetic material is not required in the calculated three-dimensional distribution;
(d) removing unbonded powdered magnetically inert material from the layer, to leave only bonded magnetically inert material in the corresponding regions; and gaps in other regions of the layer;
(e) depositing a powdered magnetic material into the gaps in the layer;
(f) bonding together powdered magnetic material of the layer in regions of the layer where presence of the magnetic material is required in the calculated three-dimensional distribution;
(g) applying a further layer of powdered magnetically inert material over the previous layer;
(h) repeating steps (g) and (c)-(f) to build up successive layers of bonded powdered magnetic material and bonded powdered magnetically inert material until the resultant structure corresponds to the calculated three-dimensional distribution of magnetic material; and
positioning the manufactured shim in the predetermined position.
